(19) United States
(12) Patent Application Publication
(10) Pub. No.: US 2011/0209177 A1
(43) Pub. Date: Aug. 25, 2011

(54) Smartphone To Control Internet TV System

(76) Inventors: Meir Sela, Cresskill, NJ (US); Stephan Wenger, Hillsborough, CA (US); Isaac Levy, New York, NY (US); Tal Shalom, Fair Lawn, NJ (US)

(21) Appl. No.: 12/903,815

(22) Filed: Oct. 13, 2010

Related U.S. Application Data
(60) Provisional application No. 61/252,544, filed on Oct. 16, 2009.

(51) Int. Cl. H04N 7/16; H04N 5/445

(52) U.S. Cl. 725/39; 725/62

(57) ABSTRACT

Disclosed are techniques to implement a web based remote control application and/or stand alone application running on an unmodified, commercially available smartphone, that is used to control an video distribution system (e.g., IPTV or video conferencing system) endpoint, for example the ones disclosed in U.S. Patent Application Ser. Nos. 61/172,355 and 61/220,061. The application connects directly to a video server that resides on an IP network (e.g., Internet), and not to (or through) the controlled endpoint. The connection to the server utilizes standard smartphone data network services to access, through the IP network, the server. Remote control commands entered by a user to the smartphone, by the means of keys, touch screen, or other smartphone user input devices, are conveyed to the server, which, in some cases, acts on those commands and, simultaneously and only when applicable, forwards them to the endpoint for local execution.

### CROSS-REFERENCE TO RELATED APPLICATIONS

The application is related to U.S. Provisional Patent Application No. 61/252,544, filed Oct. 16, 2009, for “Smartphone to Control Internet TV System,” which is incorporated by reference in its entireties herein and from which priority is claimed. The application is further related to U.S. Patent Application Nos. 61/172,355, filed Apr. 24, 2009 for “System And Method For Instant Multi-Channel Video Content Browsing In Digital Video Distribution Systems,” and 61/220,061 filed Jun. 24, 2009, for “System and Method for An Active Video Electronic Programming Guide,” which are both incorporated by reference in their entireties herein.

### TECHNICAL FIELD

The invention disclosed relates to the control of a video distribution system, for example, an Internet Protocol television (IPTV) system or video conferencing system.

### BACKGROUND ART

Smartphones are used extensively as remote controls for home theatre applications, for example the Digital Living Network Alliance provides examples in its Use Case Scenarios White Paper, June 2004, at page 11, found at [http://www.dlna.org/industry/why_dlna/DLNA_Use_Cases.pdf]. Another example is the Sonos® remote control client for the iPhone® which can be found at [http://www.sonos.com/whattobuy/controllers/iphone/default.aspx]. Further, high-end universal remote controls such as the Logitech® Harmony®, found at [http://www.logitech.com/index.cfm/remotes/universal_remotes/devices/4708&cl=us,en], include touch screens of sufficient size to readily permit user interactions. However, all these solutions have in common that the communication relationship, e.g., the communication relationship for controlling devices such as TVs, exists solely between the smartphone or remote control and the local device on the user premises.

Smartphones, today, can have screens of sizes useful for the disclosed invention, user input technologies (such as touch screens, keys, joysticks, and similar features), and connectivity based on IP protocols. They further comprise software components that allow for a smartphone-platform-independent software development. For example, most smartphones include a web browser, and many offer a streaming client, each of which is accessible through standard protocols. Many smartphones also include a Macromedia Flash client that supports motion video. Some smartphones also offer an interface that allows for downloadable applications native to the smartphone's architecture, along with a software environment that allows for the development of such applications. These smartphone-provided mechanisms can be utilized to implement a web-page application, a Flash-based application, or a native smartphone-processor application that provides functionalities in accordance with an embodiment of this invention.

Henceforth, the term “smartphone” is employed as a synonym for the use of one of the aforementioned smartphone based applications. That is, when a smartphone sends a command as a result of a user input, that means that the application on the smartphone received the user's input, processed it in order to form a command, and conveyed the command over the smartphone's network interface. Similarly, when the smartphone receives information such as an update of its screen layout or content, it is typically the application running on the smartphone that receives an update of the information from the smartphone's network interface and interprets it. However, as with many web technologies, the borders between application and content can depend on context. For example, an HTML-based application on a smartphone can be implemented such that, after any user interaction or state change, a new HTML page is received that completely replaces the previous one. In that case, the application and the content are identical. On the other hand, some native smartphone applications will receive input in an abstract form and interpret it locally, and will typically not be replaced by any normal user operation (in this example, an explicit software update is not considered as normal user operation).

The term “command” is used henceforth for all the information that is sent by the smartphone to the server with the intention to control an aspect of the server or (through the server) of the endpoint. The term “update” is used for all information sent by the server to the smartphone, whether the information is sent on the server's own initiative or whether the information is received from the endpoint.

In a video distribution system, for example an IPTV system or a video conference system, one should distinguish between equipment that is typically located on the user premises and equipment that typically resides “in the network” and is operated normally by service providers, operators, or, in case of large enterprises, perhaps by the IT department of the enterprise. The equipment that is typically located at the user premises and directly visible to the user is henceforth called the “endpoint”, whereas equipment typically located “in the network” is henceforth called the IPTV server, or simply the server. A smartphone does not fit into either category.

According to FIG. 1, a typical endpoint includes devices such as a network interface (101), a computer (102), for example, a set-top box or other type of computer, that is responsible for translating the incoming IP packets comprising media and control data (103) into an analogue or digital audio-visual signal (104), a video display (105), for example a TV screen or computer monitor, and an audio output device (106), for example, a set of loudspeakers, to render the audio-visual signal (104), as well as some form of user interface (107) and input devices (108). The typical input device is a classic remote control (which, nowadays, typically uses an infrared signal to communicate with the endpoint devices). The network interface of the endpoint connects over a network (109), for example the public Internet, another IP network, a packet network, a combination of a private IP network and public Internet, or a private network, to a server. A typical server can be in the form of a streaming server, a video-conferencing MCU, a CSWS and MBW control logic as disclosed in U.S. Patent Application Ser. No. 61/172,355, IP multicast routers, or similar devices, alone or in combination.

As depictured in FIG. 2, known prior art solutions for the use of a smartphone (201) to control a video distribution system endpoint (202), for example a IPTV system, require direct connectivity between the smartphone and functional units of the endpoint (203), for example, a set-top-box or other type of computer. The endpoint, on the other hand, communicates with the server (204) in the network. A limitation of such prior art solutions is the need to use more than one remote control to control a TV and a connected set-top-box. Universal remote controls are available that allow integrating the functionality of one or more remote controls that come with the (consumer electronic level) TVs and set-top-boxes, as well as other endpoint devices, into a single remote control unit. From a user's viewpoint, a universal remote control has clear advantages, including avoiding “clutter” in the family room and coordinated control of several devices (a single on/off button enables a plurality of endpoint devices, for example, set-top-box, TV, VCR, DVR, game console, audio receiver). Universal remote controls “talk” to each of the devices independently, or, in modern systems, occasionally though one of the devices. However, remote controls, including universal remote controls, do not influence servers directly; instead they instruct the endpoint devices only, which can, in some circumstances result in the endpoint device sending commands to a server. For example, if, in an IPTV context, a user selects a certain channel, this channel selection command is received by the set-top-box, and the set-top-box, triggered by the reception of the command, instructs the server to cease sending media of the previous channel and commence sending data of the future channel.

### SUMMARY

The disclosed subject matter is directed to methods and systems for controlling an endpoint using a device to directly access a server capable of controlling the endpoint.

Methods for using a device to control a video distribution system which includes an endpoint and a server are disclosed herein. One exemplary method includes authenticating the endpoint and the device with the server, and causing the device to communicate with the server such that the device at least partially controls the endpoint. In some embodiments, the device can be a smartphone. In the same or other embodiments, causing the device to communicate with the server includes sending commands and/or updates from the device to the server. The updates can include a web-page representation, such as HTML and/or Flash, and in some embodiments, can include a representation of an Electronic Programming Guide, graphical representations of one or more channels, and/or one or more Mini Browsing Windows. In one embodiment, partial control of the endpoint can include local changes to the server, which can include channel-up, channel-down, volume-up, volume-down, and/or off.

The method can further include causing the server to communicate with the endpoint, which, in some embodiments, can include causing the server to relay commands received from the device to the endpoint. In the same or different embodiments, causing the server to communicate with the endpoint can include causing the endpoint requests commands from the server, and causing the server to respond with queued commands in response to the request. Further, in some embodiments, authenticating the device includes enabling authentication based on different grades of access using different login credentials corresponding to each grade of access.

Systems for controlling a video distribution system which includes an endpoint and a server are disclosed herein. One exemplary system includes a device configured to communicate with the server such that the device at least partially controls the endpoint. In some embodiments, the device can be further configured to authenticate with the server and endpoint can be configured to authenticate with the server. In the same or other embodiments, the device can be a smartphone. The device can be further configured to communicate with the server by sending commands and/or updates from the device to the server.

In some embodiments, the device can be further configured to communicate instructions to effect local changes to the server such that the device at least partially controls the endpoint. In the same or other embodiments, the device can be further configured to cause the server to communicate with the endpoint, which can include causing the server to relay commands received from the device to the endpoint. The device can also be configured to cause the endpoint to request commands from the server and cause the server to respond with queued commands in response to the request. In some embodiments, the device can be configured to authenticate by enabling authentication based on different grades of access using different login credentials corresponding to each grade of access.

### BRIEF DESCRIPTION OF THE DRAWINGS

FIG. 1 is a block diagram illustrating a prior art system for the transmission and display of audio-visual signals and remote control device.

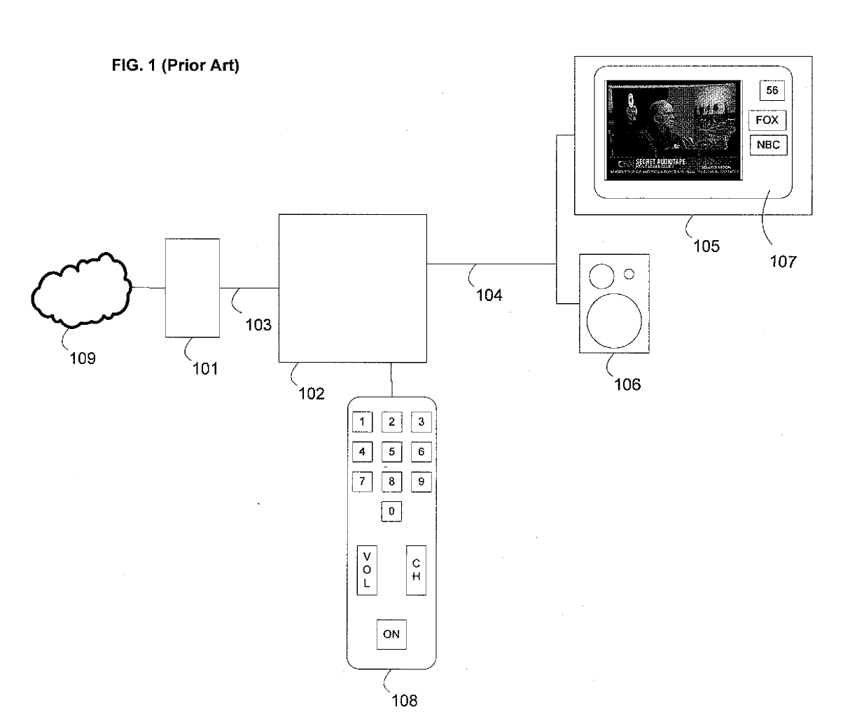

FIG. 2 is a block diagram illustrating a prior art system for the transmission and display of audio-visual signals and remote control device.

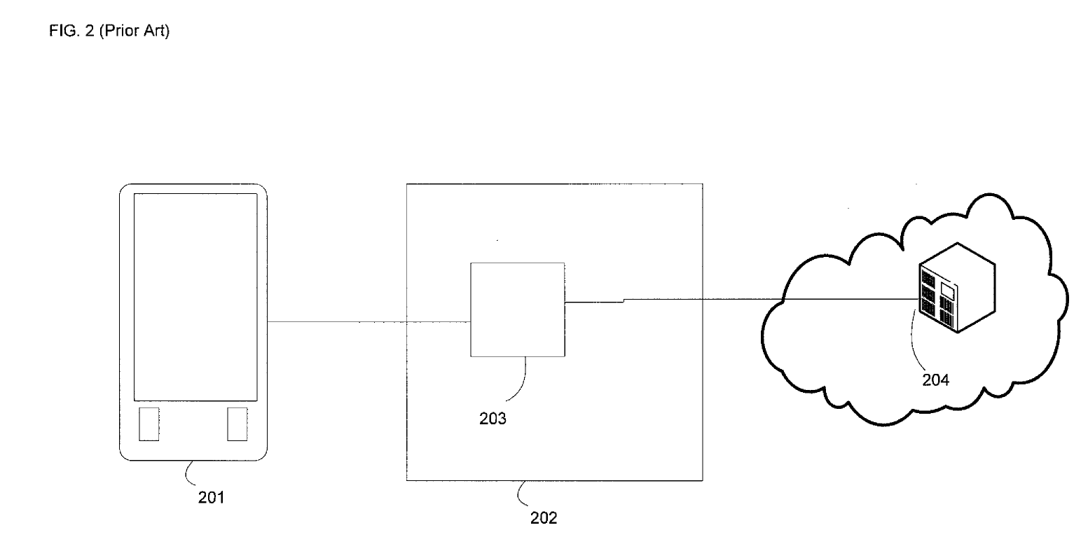

FIG. 3 is a block diagram illustrating an exemplary system for the transmission and display of audio-visual signals and remote control device in accordance with the present invention.

FIG. 4 is a block diagram illustrating an exemplary system for the transmission and display of audio-visual signals and remote control device in accordance with the present invention.

FIG. 5 is a block diagram illustrating an exemplary system for the transmission and display of audio-visual signals and remote control device in accordance with the present invention.

FIG. 6 is a block diagram illustrating an exemplary system for the transmission and display of audio-visual signals and remote control device in accordance with the present invention.

FIG. 7 is a block diagram illustrating an exemplary system for the transmission and display of audio-visual signals and remote control device in accordance with the present invention.

FIG. 8 is an exemplary endpoint video display and remote control device screen in accordance with the present invention.

FIG. 9 is a diagram illustrating an exemplary system for the transmission and display of audio-visual signals and remote control device and server message flow in accordance with the present invention.

FIG. 10 is an exemplary remote control device screen in accordance with the present invention.

FIG. 11 is a diagram illustrating an exemplary message flow between the endpoint and the server in accordance with the present invention.

Throughout the drawings, the same reference numerals and characters, unless otherwise stated, are used to denote like features, elements, components or portions of the illustrated embodiments. Moreover, while the disclosed invention will now be described in detail with reference to the figures, it is done so in connection with the illustrative embodiments.

### DESCRIPTION

The disclosed subject matter provides techniques for utilizing a remote control application on a remote control device (e.g., a smartphone) to control an Internet Protocol (IP) based video distribution system (e.g., IPTV). The remote control application can be web-based. The IPTV system includes at least an endpoint and a server. The server can be located in an IP network (e.g., the Internet), can be under the control of an entity different from the user that controls the endpoint, and can be directly accessible from devices with IP network connectivity.

In some embodiments, a user can connect a smartphone to the server, using standard web protocols. After the server authenticates the smartphone through a login process, the server can provide the smartphone with information to display on the smartphone screen (referred to herein as “updates”). The user can act on these updates by input to the smartphone. The smartphone can also send commands to the server, which the server can execute locally, forward to the endpoint, or a combination thereof.

Applications for smartphones and similar devices allow the smartphone user to control home entertainment systems, including IPTV set-top-boxes. These applications typically emulate in some form the classic, infrared-based remote controls of consumer electronic devices, in that they access only endpoint devices. Even when using enabling technologies such as the Dynamic Host Configuration Protocol (DHCP) or its more advanced successors, there is still a need for complex configuration operations, typically on both smartphone and endpoint devices. This fact alone, in addition to other factors discussed later in more detail, has led to the situation that smartphones are only rarely used as remote control replacements.

Accordingly, the disclosed techniques are directed to smartphone configurations that can directly access a server, bypassing the need to access an endpoint device and thereby providing an enhanced experience in using a smartphone to control a IP based video distribution system. In such a way, the disclosed techniques overcome the above-stated problems with current smartphone applications and further provide a number of additional advantages, as discussed herein. The server can be, from an access viewpoint, a simple web server: it is can be located in the Internet, have a publicly known and accessible IP address that can be resolved using Domain Name Service (DNS), have ports for standard protocols such as HTTP that are not blocked, and also have some form of login process for such requests that are not open to the general public. The smartphone can connect to this server and authenticate itself as a control device for a given endpoint. The server can respond by sending the smartphone information for presenting a user interface on the smartphone's screen; in simple cases that interface is not unlike can resemble the interface of a classic remote control, but in more complex cases a much more powerful and sophisticated user interface can be utilized.

Input on the smartphone's user interface can be forwarded as commands to the server, which can then interpret the commands, and act upon them either locally or by forwarding them to the endpoint; in some cases, local activity in combination with forwarding is required or desirable. Devices with a physical form factor that allow for the use as a remote control replacement, such as netbooks, high-end universal remote controls and similar, may share properties similar to smartphones, in which case they can offer a similar functionality. Likewise, since only a web browser or a Flash client is required as the software environment in some systems, a PC can act as a remote control replacement. Henceforth, while the disclosure refers only to smartphones, a person skilled in the art would understand that a similar device, with the same or a similar application, can be used, e.g., netbooks, high-end universal remote controls, or personal computers.

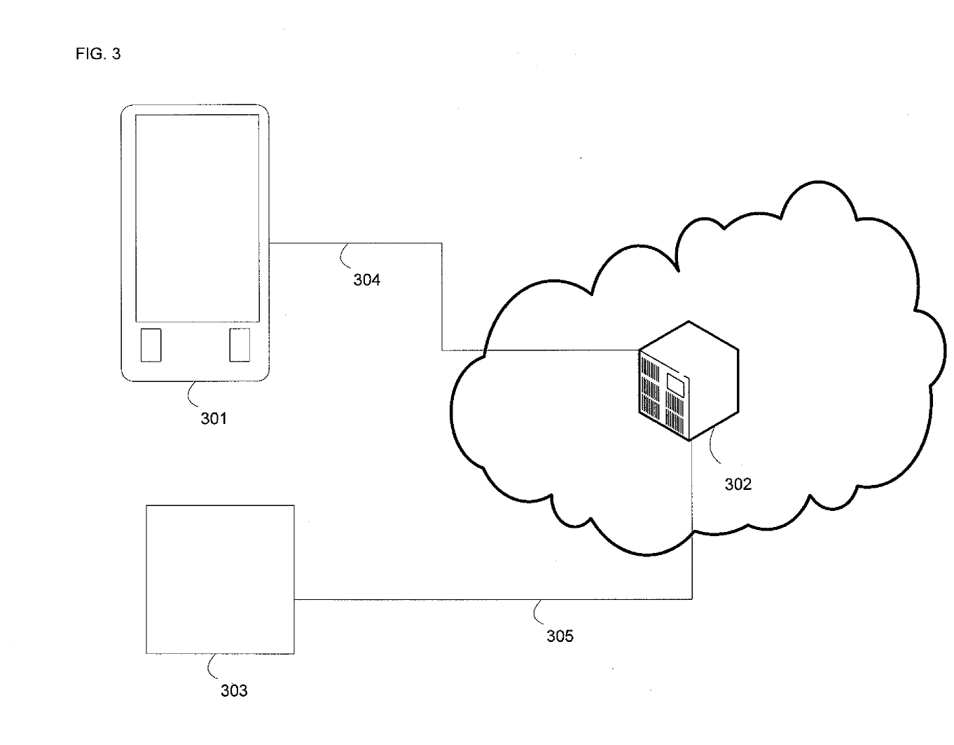

In one exemplary embodiment, as presented in FIG. 3, a smartphone (301) communicates (304) with the server (302) without directly involving the endpoint (303). Specifically, the server (302) issues updates to the smartphone (301), and the smartphone (301) sends commands to the server (302). Further, the server (302) communicates (305) with the endpoint (303). The endpoint (303) learns through communication (305) by the server (302) that a user has made a request using the smartphone (301).

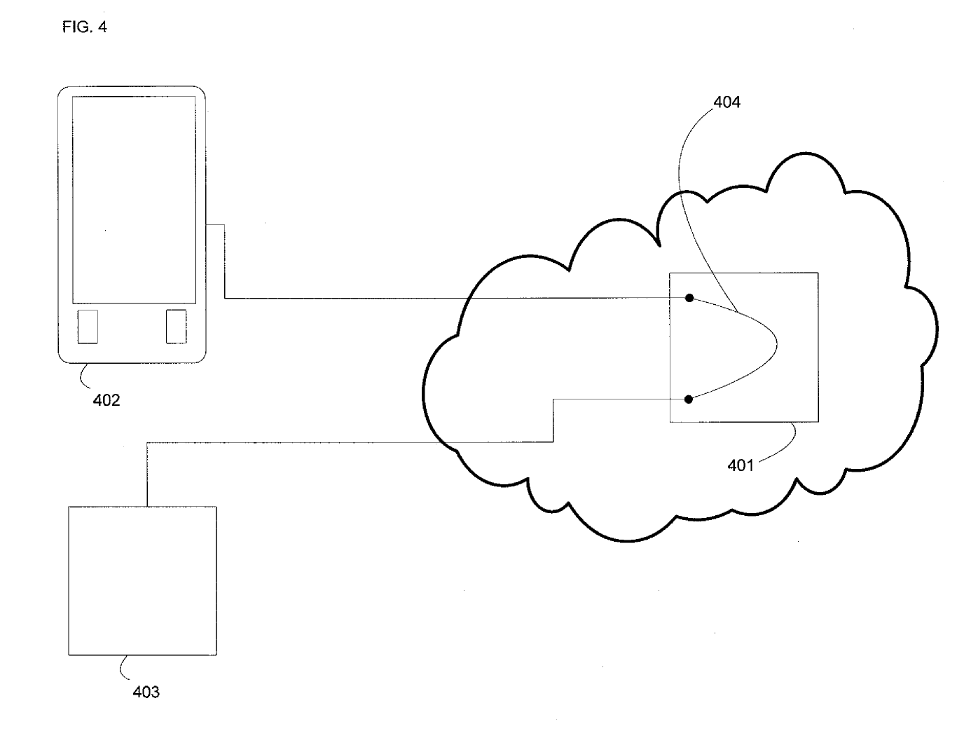

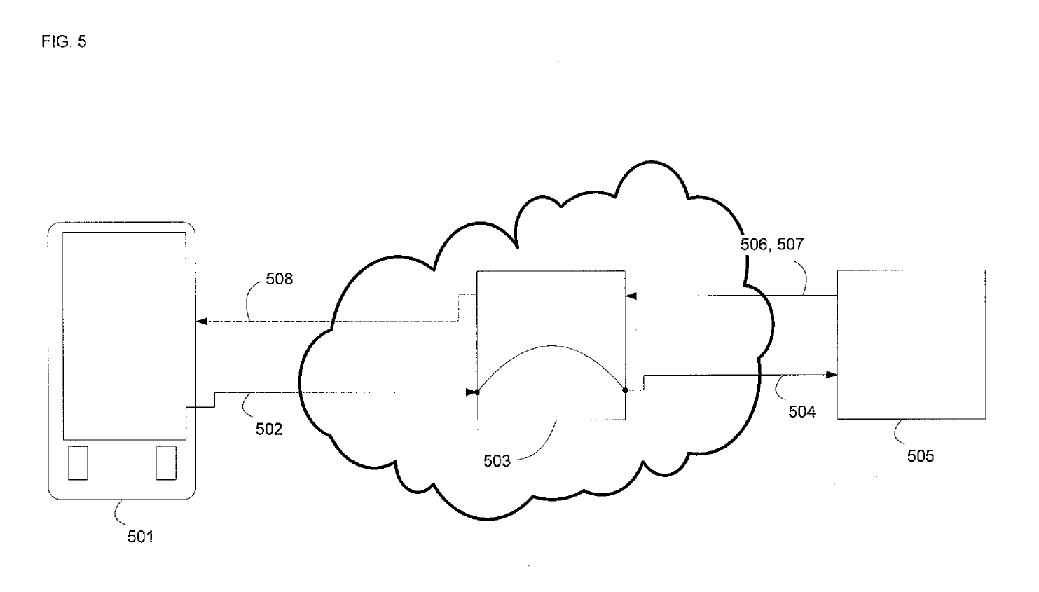

As shown in FIG. 4, in one embodiment of the invention, the server (401) acts as a relay (404) and communicates all commands received from the smartphone (402) to the endpoint (403). This configuration only needs minimal changes in the endpoint architecture, and is also a simple functionality addition to current server architectures. However, in this embodiment some of the functionalities listed below may difficult to implement, and the implementation of others may incur network traffic that is unnecessary in other embodiments. As shown in FIG. 5, for example, if a channel switch command were sent by the smartphone (501), this command can first be conveyed (502) to the server (503), then relayed (504) to the endpoint (505); at the endpoint it would be translated into messages such as “stop playing current channel” (506) and “start playing next channel” (507), and those messages would be communicated back to the server (503) for execution. Optionally, the server (503) may even communicate an update (508) to the smartphone (501) indicating that the channel switch has happened. This results in a total of at least three, probably four, control messages, that can cost network resources and also take time to be communicated.

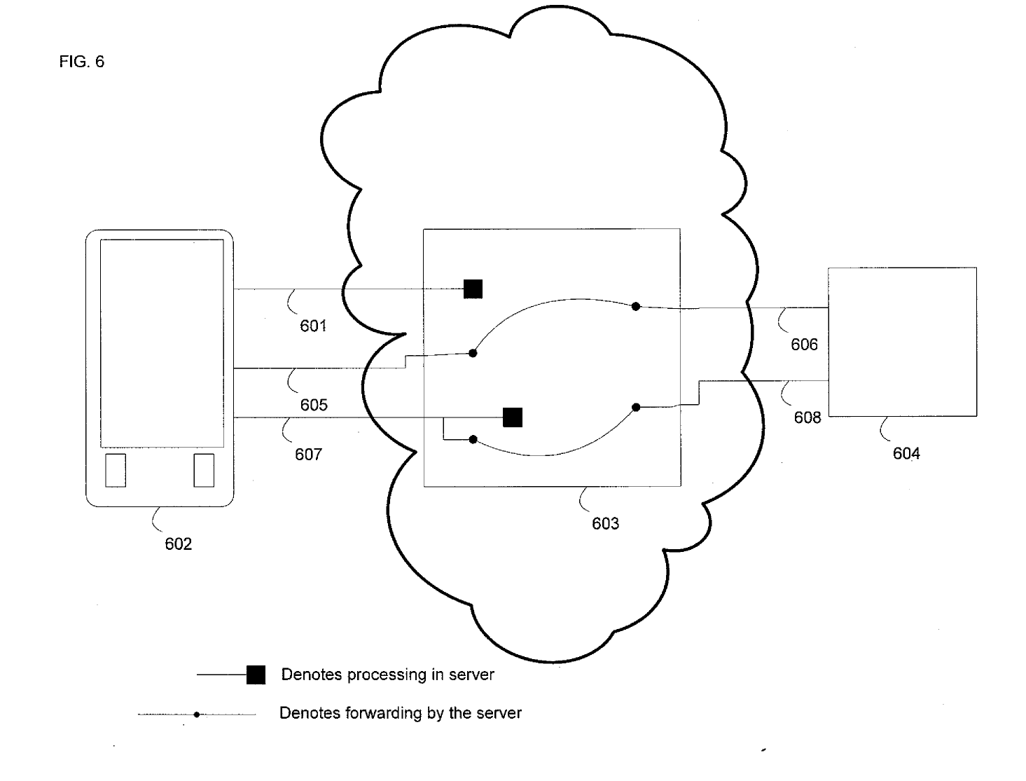

As illustrated in FIG. 6, in the same or another embodiment of the invention, on some of the commands (601) sent from the smartphone (602) to the server (603), the server (603) is able to react to without involving the endpoint (604) directly. For example, if a channel is being switched, in an IPTV context, there is not necessarily a need for the endpoint to know of this situation. When the server receives a channel switch command, it simply stops sending the current channel and commences sending the new channel. As a result, the user can see the new channel after the exchange of only one control massage.

In the same or another embodiment, other commands (605) are best handled by the endpoint (604) directly, and those commands are forwarded (606) by the server to the endpoint. For example, while it could be feasible to adjust the audio volume in the server as well, it is common practice that the audio volume management is addressed locally in the endpoint. Still, even in such a case, there is a value in having the command routed through the server. For example, parents can establish a policy in the server that limits the maximum volume of the endpoint located in a child's room—and would be able to change this policy even from a remote location through their smartphone-based access over the Internet to the server. In the same or another embodiment, there are commands (607) that may be acted upon by both server (603) and endpoint (604), and, therefore are acted upon by the server and forwarded (608) to the endpoint. One example for such a command is the on/off button: obviously, the endpoint needs to know when it should start and stop, but there is also a value of having such information at the server, for example for resource management.

Routing all commands and updates from smartphone to endpoint through the server has a number of advantages.

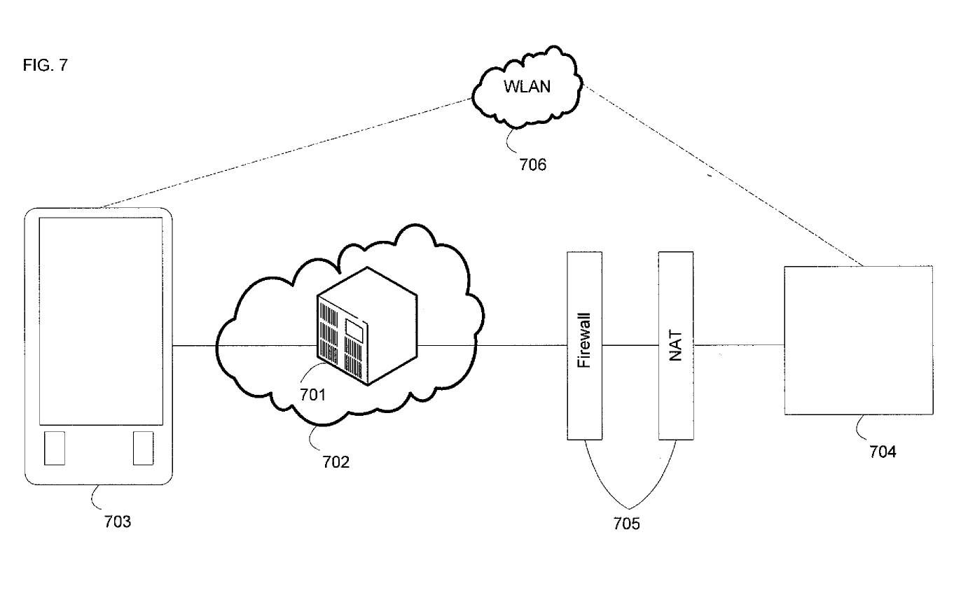

One advantage lies in the ease of installation and network managements. As depicted in FIG. 7, in most IPTV systems, the server (701) is accessible over the Internet (702), using straightforward protocols such as Domain Name Service (DNS), IP, TCP, and HTTP. That means that any properly configured smartphone (703) can access the server (701) without special user configuration. The endpoint (704), on the other hand, even today, is typically separated from the Internet (702) by a number of functional units (705), such as Network Address Translators (NATs), Firewalls, and similar, that severely limit, or render impossible, the direct access of the endpoint from the smartphone. Of course, most smartphones (703) can be configured to access the endpoint (704) directly through a network (706), for example, a wireless LAN that may exist on the user's premises, and to which both endpoint (704) and smartphone (703) may be connected. However, even this intuitive step may require the user to configure the network stack of the smartphone differently from its default settings, and/or differently from the settings the user is obliged to use in his/her office environment.

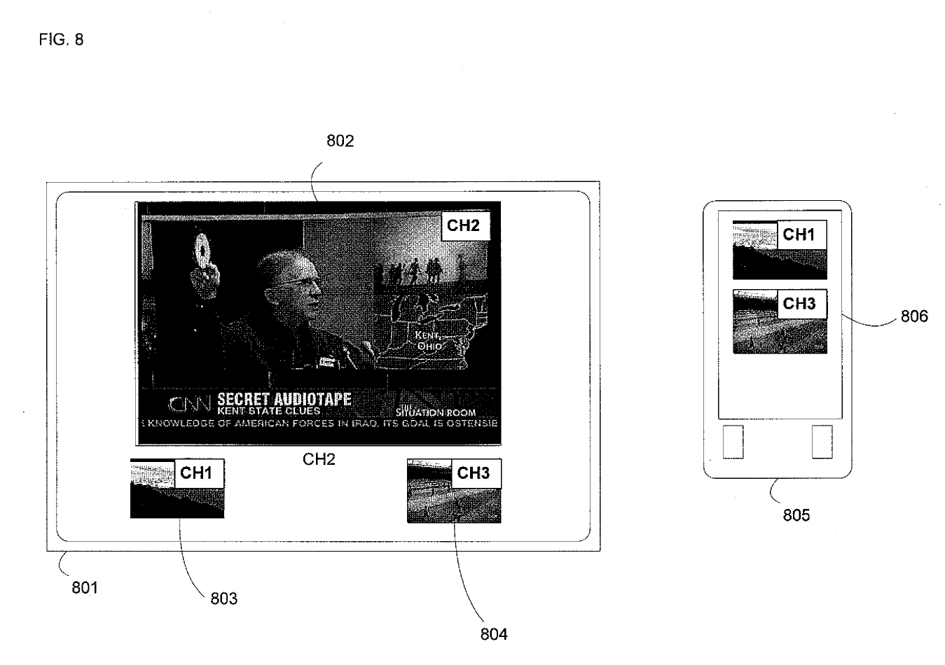

Yet another advantage of a direct connection of the server to the smartphones lies in the extension of the user interface of the IPTV endpoint beyond what is commonly known even from high-end universal remote controls. U.S. patent application Ser. No. 12/765,815, which is incorporated by reference in its entirety herein, discloses, among other things, the side channels mode. FIG. 8 illustrates another exemplary embodiment of the invention featuring the side channels mode disclosed therein. An exemplary user experience of the side channels mode is such that, on the video display (801), for example, a TV screen, the user can always see the current TV channel in full resolution (802) in a main window, and the “previous” (803) and “next” channel (804) in Mini Browsing Windows (MBWs). The precise semantics of “previous” and next” depend on the user and operator preferences and are elaborated upon in the aforementioned patent application. In the exemplary embodiment illustrated in FIG. 8, the server sends the media data related to the MBWs of the side channels mode to the smartphone (805) for display (806), instead or in addition of sending them to the endpoint itself, allow all pixels of the endpoint video display (801) to be used for the current channel. If the media data were sent only to the smartphone (805), then one would lose the fast channel switch feature of the side channels mode at the endpoint, as disclosed in U.S. patent application Ser. No. 12/765,815, but would otherwise retain the functionality. If the MBW related media data were sent to both smartphone (805) and endpoint (801), one would keep the fast channel properties at the endpoint, but can omit the display of the MBWs, thereby saving screen space that can be utilized for other purposes.

Yet another advantage is the ability to track user usage and record it on the server for analysis. Even in a traditional IPTV setting, the server has some information of the user's watching habits, such as knowledge of channels being watched. However, when all commands are routed through the server, additional information becomes available, such as the typical audio volume the user is selecting. This can help an operator of the server to enable new services. In one example, if the operator learns that a user often uses an exceedingly loud setting of his/her TV, the operator can assume that the user may have a hearing problem and inform the user about this presumed situation.

As discussed below, routing commands through the server also enables many modes of advanced parental control.

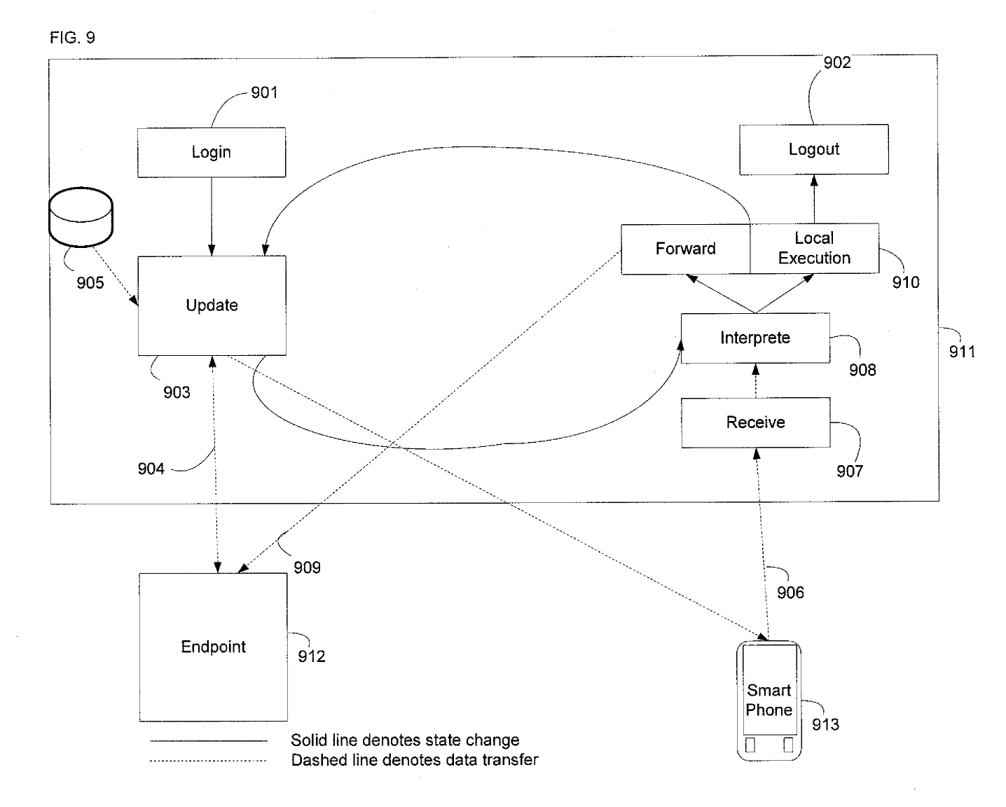

In order to integrate a smartphone into an IPTV system according to the invention presented, a number of issues should to be resolved. An exemplary integration scheme is illustrated in FIG. 9, which shows a hybrid between a state diagram and a data flow chart.

First, in most practical cases the server (911) needs to become aware of that it should listen not only to commands that may still come through the direct connection (904) of the endpoint (912) to the server (911), but also to commands (906) from the smartphone (913). In one embodiment, this requires a login process (901) (implemented through software or hardware) located at the server, which processes login credentials entered by a user into the smartphone and login credentials entered by a user into the endpoint, and authenticates the smartphone (913) as a legitimate remote control for a given endpoint (912). In this embodiment, the association of the smartphone (913) and the endpoint (912) is based on the use of identical, and IPTV-system wide unique login credentials. That is, the user logs in, both on the endpoint (912) and on the smartphone (913), with the same login credentials.

In the same or another embodiment, an endpoint that has a first user logged in can also be controlled by a second user over the smartphone, where the two users are employing different login credentials. This will typically require a pre-configured association of endpoints and login credentials. An advantage of using different login credentials on the endpoint itself and on the smartphone associated with the endpoint lies in that it enables additional usage forms as compared to the use of a single login credential. For example, the user of the smartphone can have higher privileges than the user of the local endpoint control, and, as a result, can override local commands. One example of this may be parental control: a parent using the smartphone can switch off a child's endpoint at any given time, and (assuming network coverage) from any given place. In the same or another embodiment, if the server and the smartphone implement a sufficiently powerful update mechanism, the parent can have, at any given point in time, information from the child's endpoint, such as which channel the child is currently watching/browsing. A disadvantage of allowing more than one user being associated with a given endpoint lies in implementation complexity.

In the same or another embodiment, a given endpoint may have more than one user with different grades of access. One example is parent users that have full access, and children users that have access only to certain channels and certain periods of time. In another example, a user may have limited access to pay programs.

Second, should be logout process (902) (implemented through software or hardware) located at the server that de-authenticates the smartphone (913) from a given endpoint (912). In an exemplary embodiment, the logout process may be invoked explicitly by the smartphone user. In the same or another embodiment, the logout process may be invoked through a timeout mechanism that may trigger after specific extended periods of user inactivity. The latter is especially important as smartphone users may easily lose connectivity to the server in certain environments.

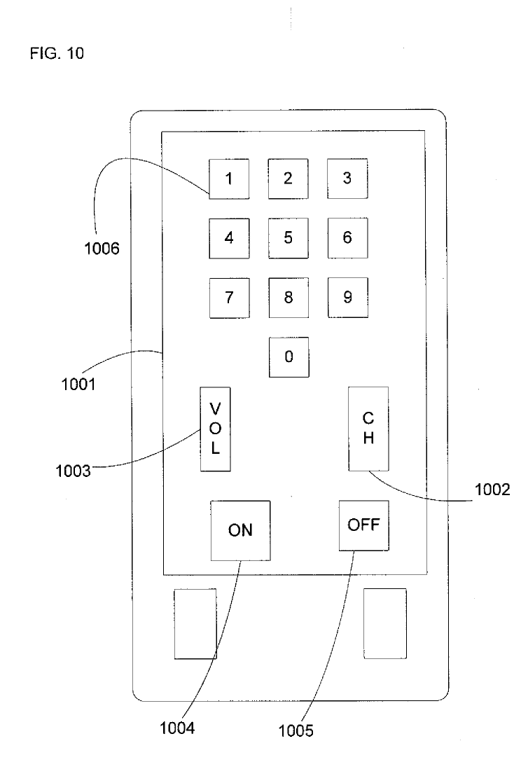

Third, the content to be sent for display on the smartphone's screen (update 903) needs to be generated in the server, based on the server's information of state, but possibly also based on information (904) that the endpoint has forwarded to the server. According to FIG. 10, in one exemplary embodiment, the smartphone screen (1001) can be static and offer the “keys” that a traditional remote control may display: channel up/down (1002), volume up/down (1003), on (1004), off (1005), and perhaps numeric keys to directly enter a channel number (1006). In the same or another embodiment, the smartphone screen can include a user-configured electronic program guide with a sophisticated user interface. U.S. patent application Ser. No. 12/821,782, which is incorporated by reference in its entirety herein, contains examples. Channels can be grouped according to user-selected criteria (for example: all sports channels), and can be displayed by still images containing channel name, channel logo, or other graphic motifs that are intuitively understood by the user, or a combination thereof. The update, when displayed, can contain navigation buttons that allow navigating through the groups of channels. The smartphone screen can reflect directly the user interface displayed at the endpoint video display, scaled down to a resolution that can be accommodated by the smartphone screen. This allows for an intuitive use of the smartphone in such cases where one user can view the smartphone screen and the endpoint video display at the same time. In the same or another exemplary embodiment, the channels may be represented on the smartphone screen by smartphone-based MBWs containing motion video as broadcasted over those channels, again as described, e.g., in U.S. patent application Ser. No. 12/821,782. Many other configurations for the smartphone screen can also be utilized. Returning to FIG. 9, while, in most cases, the server (911) generates the update (903) dynamically, the layout (905) to which the server adheres when generating the update dynamically may be fixed or user-configurable, the latter typically within constraints set by the operator.

In many cases, the update (903), when displayed on the smartphone (913), contains one or more screen areas that are “clickable,” or selectable by the user. The update contains instructions to the extent that, once the user clicks on one of the clickable areas, the smartphone sends a command (906) to the server. These commands can be abstract, such as “channel up”, “channel down”, or they can be non-abstract, such as “click at coordinates x=100, y=200”), and interpreted in the server according to its knowledge of what is currently being displayed on the smartphone screen.

The update can be represented in HTML, but other content representations such as Flash can also be used. For example, in the case of motion video, embedded windows of a streaming client can be used. The choice of content representation language is a tradeoff between the width of deployment of the language, the computational complexity of the browser implementation (which may have a direct influence on the battery life of the smartphone), and the desired level of functionality.

Fourth, in the server, the incoming commands (906) from a smartphone should be received (907), interpreted (908), optionally forwarded to the endpoint (909) in an identical or modified format, and optionally executed locally at the server (910). In one exemplary embodiment, the server forwards all commands received directly, and without modification, to the endpoint.

In the same or another embodiment, only the commands “channel up”, “channel down”, “volume up”, “volume down”, and “off” may be recognized. In this embodiment, the server, upon receiving a “channel up” command, terminates sending media data related to the current channel to the endpoint and commences sending media data related to the next “channel up,” for example, the next channel in natural ascending numerical order or the next channel in ascending order that has been specified as a “favorite channel” for this user. “Channel down” operates similarly. “Volume up” and “Volume down”, when received, are forwarded to the endpoint, using an endpoint control protocol. When an “off” command is received, this command is forwarded to the endpoint. Further, all media data transmission to this endpoint is terminated and any server-side resources related to this endpoint are released.

In the same or another embodiment, the server implements an electronic program guide. U.S. patent application Ser. No. 12/821,782 discloses several alternative realizations of such an electronic program guide. For example, the guide lists channels according to categories on individual pages. A user can select a category, and a channel within the category, through commands such as “select channel/page”, “page up”, cursor movement commands “up/down/right/left”, and so on. On the endpoint video display, the available channels are displayed as Mini Browsing Windows, and audio is rendered only for that Mini Browsing Window on which the focus lies (i.e. where the cursor is located). On the smartphone screen, the Mini Browsing Windows are replaced by icons representing the channels. Since it can be inconvenient to have the smartphone rendering the audio, the smartphone can display a marker for the icon of the channel that carries audio at the endpoint. For example, the channel icon may be highlighted. The server can act on commands from the smartphone locally, and send an update to the smartphone reflecting the user's choice. In addition, the server may also send information analogous to an update to the endpoint, thereby keeping the screen state of both smartphone screen and endpoint video display synchronized. It should be noted that a similar behaviour can also be achieved by having the server forwarding the command without modification to the endpoint; the endpoint then interprets it and sends back its own requests for state change to the server, upon which the server acts.

Commands are advantageously coded in XML, but can be coded in other representation languages.

Next, an embodiment suitable for use in a commercial application will be described.

In this preferred embodiment, the authentication is handled by the use of identical user identifications in both smartphone and endpoint. That is, a smartphone user is authenticated to control an endpoint once he/she is logged into the endpoint, and uses the same login credentials to authenticate himself/herself during the login process on the smartphone.

On the command path, the server acts only as a relay, in that it forwards any commands received from the smartphone to the endpoint without modifications. Further, updates are always triggered by messages stemming from the endpoint; potentially, but not always, originating from the smartphone, as the endpoint may also be operated under a local control, or may have its own mechanisms (such as a sleep timer) that may issue communication from endpoint to server without user interaction.

So far, the disclosure has used abstract terms such as “sending” commands from smartphone to server. Similarly, the disclosure has used abstract terms for the communication between server and endpoint.

While a person skilled in the art should be able to devise many other means of this communication, below disclosed is one implementation in the preferred embodiment.

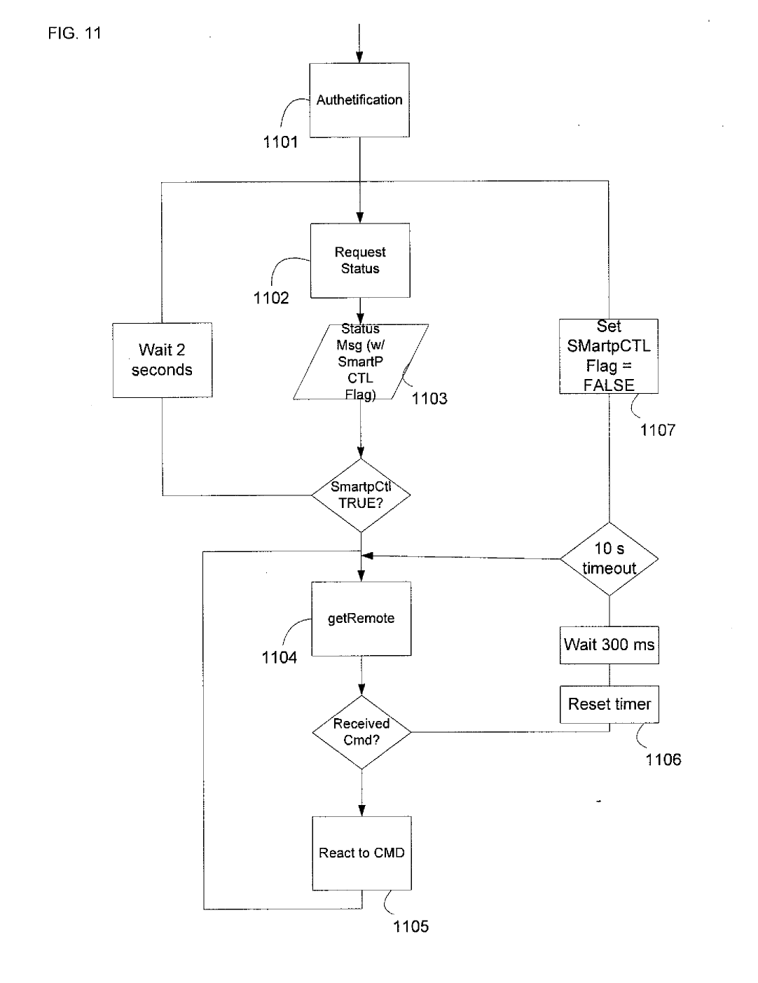

In the preferred embodiment, the protocol engine works according to a flowchart depicted in FIG. 11. After the user has authenticated (1101) himself/herself at the endpoint, the endpoint requests from the server in regular intervals, for example every two seconds, the status, through a request for status message (1102). The status reflects state information available only at the server. One element of the status message (1102) is the existence of smartphone based control, which, after user login at the endpoint, is typically “false”, as the user has logged in only at the endpoint and not yet at the smartphone.

Once the user also logs into the smartphone, this fact is communicated to the endpoint as a reply to the next request for status message, by setting the smartphone-based control flag to “true” (1103). The endpoint reacts to the reception of this indication as follows: first, the endpoint starts sending a getRemoteCommands message (1104) at intervals appropriate for polling, for example every 300 ms. The server reacts to these messages by forwarding any commands received from the smartphone that have been queued between the last forwarding of commands and the reception of the message (1105). Second, every time a command has been forwarded, the endpoint resets a timeout counter with, for example, 10 seconds duration (1106). If no further command becomes available at the server in these 10 seconds and, therefore, no further command is forwarded to the endpoint, the endpoint assumes that the smartphone is no longer used as a remote control, resets the smartphone-based control flag to “false”, and stops sending getRemoteControl commands (1107), until such time it learns through the reply of the regular status message that more commands have become available (1103).

This two-stage process helps to keep the server and network load down, while still offering swift reaction times to input entered by the user into the smartphone. A user may have to wait up to two seconds (plus network delay) for a reaction to his/her input on the smartphone, but any subsequent input on the smartphone is reacted on by the endpoint within very brief periods of time.

The described communication protocol has the advantage of being closely aligned with the communication relationship used by traditional web communication protocols such as HTTP. HTTP does not use persistent connections; rather, a connection is established to execute a single transaction, and torn down after this transaction. Though there are many architectural advantages of such a strategy, some embodiments of the invention do not use such an HTTP communication strategy. Many other forms of implementation of this communication process can be used. For example, the server can open a persistent connection between the endpoint and the server, and the server and the smartphone. Through this connection the server would be able to initiate a command on the endpoint, without the endpoint querying the server through a getRemoteControl message. This can be accomplished with several technologies, including opening a socket connection between the server and endpoint with a specific port, the use of a Flash Media Server with which we can open a two way connection to the flash application, or the use of Microsoft Silverlight instead of Flash with which one can establish a duplex web service connection to .NET server. Other modifications that are within the spirit and scope of the present invention can likewise be achieved.

1. A method of using a device to control a video distribution system, wherein the system comprises at least one endpoint and one or more servers, the method comprising:
a) authenticating the endpoint and the device with at least one of the one or more servers; and
b) causing the device to communicate with the authenticating one or more servers such that the device at least partially controls the endpoint.

2. The method of claim 1, wherein the device comprises a smartphone.

3. The method of claim 1, wherein the causing comprises sending commands from the device to the authenticating one or more servers.

4. The method of claim 1, wherein the causing comprises sending updates from the device to the authenticating one or more servers.

5. The method of claim 4, wherein the updates comprise a web-page representation.

6. The method of claim 5, wherein the web-page representation comprises at least one of HTML and Flash.

7. The method of claim 4, wherein the updates comprise a representation of an Electronic Programming Guide.

8. The method of claim 4, wherein the updates comprise graphical representations of one or more channels.

9. The method of claim 4, wherein the updates comprise one or more Mini Browsing Windows.

10. The method of claim 9, wherein the content of the Mini Browsing Windows is distributed using a streaming protocol.

11. The method of claim 1, wherein the communication comprises instructions to effect local changes to the authenticating one or more servers such that the device at least partially controls the endpoint.

12. The method of claim 11, wherein the local changes comprise at least one of channel-up, channel-down, volume-up, volume-down, and off.

13. The method of claim 1, further comprising
c) causing the authenticating one or more servers to communicate with the endpoint.

14. The method of claim 13, wherein causing comprises causing the authenticating one or more servers to relay commands received from the device to the endpoint.

15. The method of claim 13, wherein causing comprises causing the endpoint to request commands from the authenticating one or more servers, and causing the authenticating one or more servers to respond with queued commands in response to the request.

16. The method of claim 1, wherein the authenticating comprises enabling authentication based on different grades of access using different login credentials corresponding to each grade of access.

17. A system for controlling a video distribution system, wherein the video distribution system includes at least one endpoint and one or more servers, comprising:
a device configured to communicate with one or more servers such that the device at least partially controls the endpoint.

18. The system of claim 17, wherein the device is further configured to authenticate with at least one of the one or more servers and the endpoint is configured to authenticate with at least one of the one or more servers.

19. The system of claim 17, wherein the device comprises a smartphone.

20. The system of claim 17, wherein the device is further configured to communicate with the one or more servers by sending commands from the device to the one or more servers.

21. The system of claim 17, wherein the device is further configured to communicate with the one or more servers by sending updates from the device to the one or more servers.

22. The system of claim 21, wherein the updates comprise a web-page representation.

23. The system of claim 22, wherein the web-page representation comprises at least one of HTML and Flash.

24. The system of claim 21, wherein the updates comprise graphical representations of one or more channels.

25. The system of claim 21, wherein the updates comprise one or more Mini Browsing Windows.

26. The system of claim 25, wherein the content of the Mini Browsing Windows is distributed using a streaming protocol.

27. The system of claim 17, wherein the device is further configured to communicate instructions to effect local changes to the one or more servers such that the device at least partially controls the endpoint.

28. The system of claim 27, wherein the local changes comprise at least one of channel-up, channel-down, volume-up, volume-down, and off.

29. The system of claim 17, wherein the device is further configured to cause the one or more servers to communicate with the endpoint.

30. The system of claim 29, wherein the device is further configured to cause the one or more servers to relay commands received from the device to the endpoint.

31. The system of claim 29, wherein the device is further configured to cause the endpoint to request commands from the one or more servers, and cause the one or more servers to respond with queued commands in response to the request.

32. The system of claim 18, wherein the device is configured to authenticate by enabling authentication based on different grades of access using different login credentials corresponding to each grade of access.
